(19) United States
(12) Patent Application Publication
(10) Pub. No.: US 2007/0274246 A1
(43) Pub. Date: Nov. 29, 2007

(54) Reliable multicast in a network having a power saving protocol

(76) Inventor: Adrian P. Stephens, Cambridge (GB)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/441,661

(22) Filed: May 26, 2006

(51) Int. Cl. H04H 1/00

(52) U.S. Cl. 370/312

(57) ABSTRACT

A reliable multicast for a power saving protocol such as IEEE 801.11n is described. A TSPEC frame is modified to carry the multicast address, which address can be represented in a short-hand form with, for instance, and AID. During the downlink times, the AID may also be used to identify the multicast downlink allocation in a PSMP frame.

### FIELD OF NETWORKS SUCH AS LOCAL AREA

The invention relates to the field of networks such as local area networks (LANs).

### PRIOR ART AND RELATED ART

Multicasting is an efficient method of communicating data to a group since, for example, a single transmission of data to multiple stations is possible.

In some wireless network protocols, stations are assigned times for downlink and uplink transmissions to reduce their power consumption. This creates a problem for multicasting since all multicast addressees may not be listening at the same time to receive multicast data.

One proposed protocol embodying this power saving feature is the proposed standard IEEE P802.11n/D1.0(March 2006). This proposed standard employs a traffic control frame which defines a service interval used by the power save multi-poll (PSMP) transmitter and PSMP receivers.

### BRIEF DESCRIPTION OF THE DRAWINGS

FIG. 1 illustrates a traffic specification frame as proposed for the 802.11n standard.

FIG. 2 illustrates a modified traffic specification frame, as modified for multicasting.

FIG. 3 is a flow diagram illustrating steps occurring at an access point (AP) to support multicasting in the power saving protocol.

FIG. 4 illustrates a PSMP frame and the ensuing downlink and uplink transmissions for a multicast operation.

### DETAILED DESCRIPTION

A method for implementing a reliable multicast in a network protocol employing power saving techniques with scheduled transmissions and/or reception is described. The following description is focused on the proposed standard IEEE 802.11n. It will be apparent to one skilled in the art, that the teachings of the present invention may used in other networks.

In the context of the proposed IEEE 801.11n/D1.0 (March 2006) standard (hereinafter the “Standard”), two parts of the Standard are modified to achieve a reliable multicast. First, the traffic specification frame (TSPEC) is modified to invoke the multicast flow. Secondly, the power save multi-poll (PSMP) sequence flow is changed to ensure that a station (STA) receiving the multicast data is awake to receive it, and further that it transmits an acknowledgement in its scheduled uplink time.

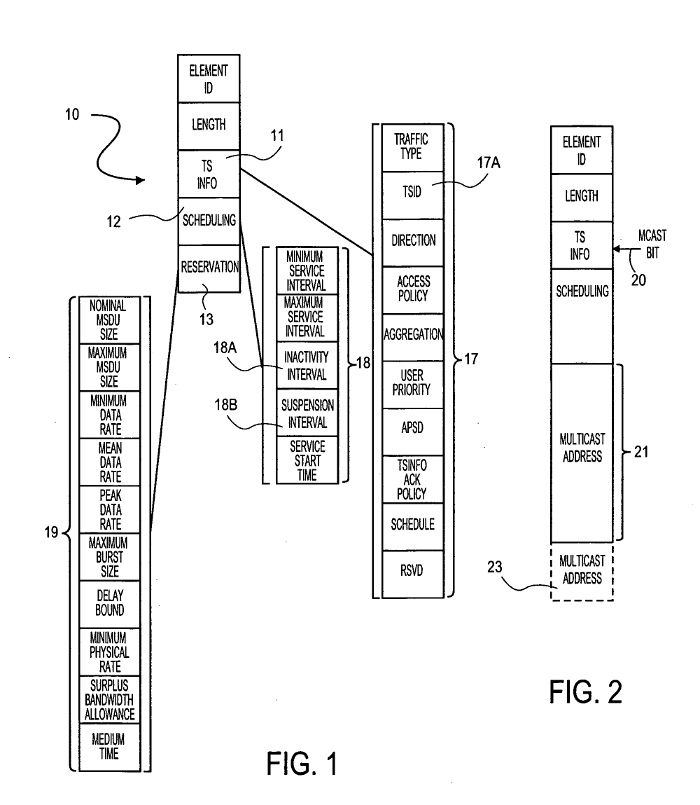

Referring first to FIG. 1, the TSPEC frame 10 for the Standard is shown with its major parameters, specifically element ID, length, traffic stream (TS) info 11, scheduling 12, and reservation 13. Detailed fields of the TS information parameters (fields 17), the scheduling parameters 12 (fields 18), and the reservation parameters 13 (fields 19) are also shown. In general, the TSPEC frame allocates resources of the access point (AP) by modifying the AP's schedules. The scheduling parameter 12 controls the PSMP scheduling by defining a service interval, as indicated by the fields 18. The reservation parameter 13, as indicated by its fields 19, reserve time for the downlink transmissions (DLT) and uplink transmissions (ULT).

The TSPEC frame of FIG. 1 is modified, as indicated in FIG. 2, so that the frame is recast for reliably multicasting. First, to indicate the multicast function, in one embodiment, a flag is set by changing the state of a reserved bit to signify multicast flow. As indicated by arrow 20, a reserve bit in the TS information field is reset (e.g. bit 17). Other mechanisms within the TSPEC may be used to indicate the reliable multicast such as a combination of bits which are recognized as invoking multicasting.

Once the multicast flag is set, fields within the TSPEC frame can be redefined to carry a multicast address such as a 6-byte address. For example, the Inactive Interval field 18A and the Suspension Interval field 18B, both of which are four byte fields, may be used for this purpose. These are indicated as the multicast address 21 in FIG. 2. Alternatively, the TSPEC frame can be extended as indicated by the extension 23 of FIG. 2, to include the multicast address.

In still another embodiment, a shortened version of the multicast address may be assigned. One of the fields from FIG. 1 may be used to carry this shortened version of the multicast address or, alternatively, the shortened version of the multicast address can be added to the frame of FIG. 2 in lieu of adding the entire multicast address 23. Alternatively, the AP may assign an unused association ID (AID) to represent the multicast address.

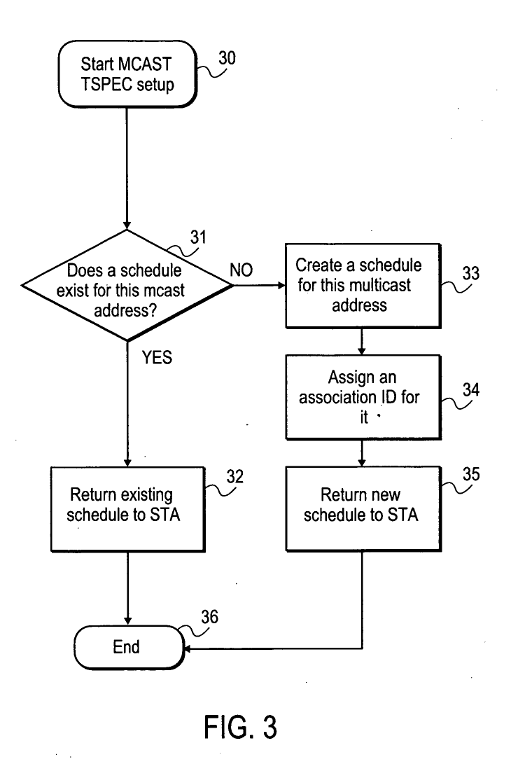

The multicast setup process is illustrated in FIG. 3. At step 30, a STA sets the flag, such as setting bit 20 of FIG. 2, and provides the multicast address to the AP. Next, as indicated at step 31, the AP upon receiving the TSPEC frame, determines if it has already stored a schedule for the particular multicast address. If it does, as indicated at step 32, it can return the existing schedule to the STA. On the other hand, if it does not have a schedule, it creates a schedule for the address, as indicated at step 33 which it stores for later use. It may, as indicated at step 34, assign a shortened version of the address by the assignment of an AID. Then, the AP returns the new schedule to the requesting station, as indicated at step 35.

The AP also creates a block acknowledge (BA) agreement by sending an ADDBA frame to the STA using the TSPEC ID (TSID) 17A of FIG. 1, initially selected by the STA. This is a departure from the existing Standard in that this agreement is associated with the multicast TSID, otherwise no changes are made to the Standard's BA setup process.

The stored multicast schedule for a multicast address is deleted, as indicated at step 36, on any one of several occurrences such as being timed-out for lack of use, BA time-out or expressly deleted by the STA. On this occurrence, the AP removes the schedule for that particular multicast address, and if an AID has been assigned, it may be reused.

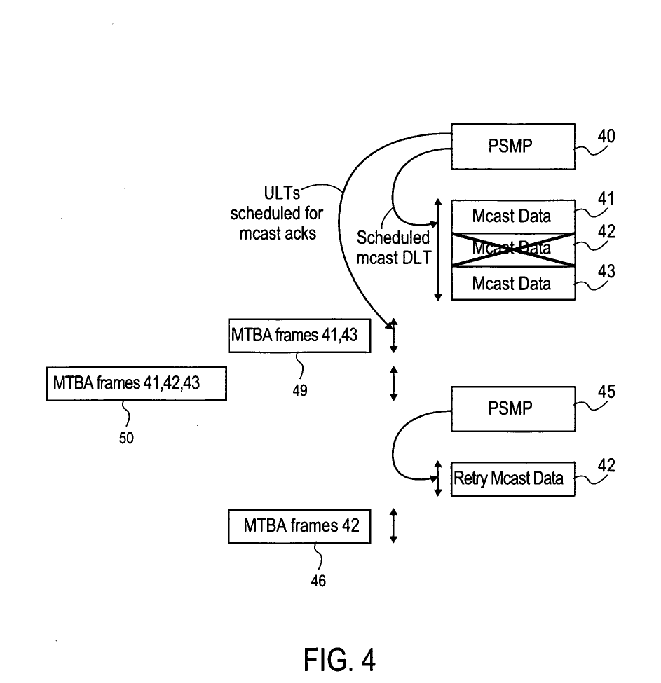

Referring now to FIG. 4, a PSMP frame 40 is illustrated. In general, these MAC control frames provide a time schedule used by the PSMP transmitters and receivers. In the Standard, the schedule begins immediately following the transmission of the frame 40, and like frames. For the multicast operation, this frame is modified to contain the multicast address. For instance, the multicast address may be placed in the receiver address field, thus, the PSMP serves only a single multicast address. Alternately, a broadcast AID field may be used in a scheduled downlink. Still alternatively, an assigned AID is used for the multicast address for the downlink transmission.

The PSMP field 40 includes the downlink transmission (DLT) times for the multicast transmission as well as the uplink transmission (ULT) for the acknowledgements. Each STA checks the PSMP frame for its respective multicast groups and determines the appropriate DLT(s). This ensures that it will be awake to receive during the appropriate DLTs.

As indicated in FIG. 4, three blocks 41, 42 and 43 are transmitted following the PSMP frame 40, as determined by the DLT schedule for a particular multicast address. One of the blocks, 42, includes an “X” to indicate that block 42 was not received by all the multicast addressees.

During the ULT, the multicast traffic ID block acknowledgements (MTBA) frames are returned by the STA's, as indicated by frame 49 and 50. The frame 49 indicates acknowledgement for the blocks 41 and 43, while the frame 50 from another STA indicates acknowledgements of all three frames 41, 42 and 43. Following the subsequent PSMP frame 45, a retry of the multicast data (block 42) is illustrated with another acknowledgement frame 46 indicating an acknowledgement for block 42.

Thus, a reliable multicast protocol has been described compatible with the Standard.

What is claimed is:

1. A multicast method for a wireless network comprising:
notifying an access point of a multicast request;
scheduling a downlink time for the transmission of multicast data; and
multicasting the data from the access point during the downlink time to multicast addressees.

2. The method of claim 1, wherein each multicast addressee acknowledges receipt of the data.

3. The method defined by claim 1, wherein the access point stores a schedule for the multicast request which is used for later requests for the same multicast address.

4. The method defined by claim 1, wherein notifying an access point of a multicast request includes the use of a multicast address.

5. The method defined by claim 4, including the step of assigning an identification field to represent the multicast address.

6. The method defined by claim 1, wherein the notifying comprises redefining field in a traffic specification frame to contain a multicast address.

7. The method defined by claim 1, wherein the downlink time is contained in a power saver multi-poll frame.

8. A method for operating an access point (AP) in a wireless network having a plurality of stations (STAs) comprising:
receiving a multicast request including a multicast address in a traffic specification frame;
scheduling a downlink time for multicast addressees to receive multicast data; and;
multicasting the data during the downlink time.

9. The method defined by claim 8, wherein fields within the traffic specification frame are redesignated to carry the multicast address.

10. The method defined by claim 8, wherein the traffic specification frame is lengthened to accommodate the multicast address.

11. The method defined by claim 8, including storing the schedule for the multicast address for a predetermined period for use with other requests for the same multicast address.

12. The method defined by claim 8, including assigning an association ID (AID) to represent the multicast address.

13. The method defined by claim 8, including establishing a block acknowledgement (BA) agreement for the multicasting by sending an ADDBA frame to the addressees.

14. The method defined by claim 8, including the steps of: storing the schedule; and checking to determine if a schedule is stored corresponding to the multicast address prior to scheduling.

15. The method defined by claim 14, including deleting the schedule after a determined period.

16. A method for operating a station (STA) in a wireless network comprising:
recognizing a multicast address as identifying a group to which the STA belongs;
receiving downlink transmission times during which it should listen for blocks of data; and
receiving an uplink transmission time during which it should acknowledge receipt of the data;
listening during the downlink time for data; and
acknowledging receipt of data during the uplink time.

17. The method defined by claim 16, wherein the acknowledgement of the data is done for each block of data received.

18. The method defined by claim 16, including recognizing a shorter form of the multicast address.

19. The method defined by claim 18, wherein the shorter form is an association ID.

20. The method defined by claim 16, wherein the multicast address, downlink and uplink transmission times are received in a power save multi-poll frame.
